(19) United States
(12) Patent Application Publication
(10) Pub. No.: US 2007/0134995 A1
(43) Pub. Date: Jun. 14, 2007

(54) Electrical terminal

(76) Inventor: Xiang Xu, Jiangso (CN)

Correspondence Address: Stephen Z Weiss;Molex Incorporated, 2222 Wellington Ct, Lisle, IL, 60532, US

(21) Appl. No.: 10/579,326

(22) PCT Filed: Nov. 19, 2004
(86) PCT No.: PCT/US04/39084

§ 371 Date: Feb. 8, 2007

(30) Foreign Application Priority Data
Nov. 20, 2003 (CN) 20100684 . X

(51) Int. Cl. H01R 13/24

(52) U.S. Cl. 439/824

(57) ABSTRACT

An electrical terminal (30) includes a first contact member (32) having an outer pressure contacting end portion (32a) of a given diameter for pressure engaging a first electrical device. The first contact member has an inner end portion (32b) of a diameter at least slightly larger than the given diameter of the outer end portion. A second contact member (34) has a front pressure contacting end (34a) for pressure engaging a second electrical device. The second contact member has a rear end (34b) with a hole (38) for reciprocally receiving the inner end portion (32b) of the first contact member (32). A restricted stop is formed at the rear (34b) end of the hole (38) for abutting the inner end portion of the first contact member to define an outer limit position of the first contact member. A biasing member (36) is disposed in the hole in the second contact member and is engageable with the inner end portion of the first contact member. The biasing member resiliently biases the first and second contact members in opposite directions.

### FIELD OF THE INVENTION

This invention generally relates to the art of electrical connectors and, particularly, to a double-ended electrical terminal for pressure-engagement between a pair of electrical devices.

### BACKGROUND OF THE INVENTION

FIG. 1A shows a conductive electrical terminal, generally designated 10, which can be used in electrical connectors, testing probes or the like, according to the prior art. The terminal is an assembly which includes a conductive housing 12, a contact member 14 and a coil spring 16. The contact member has a reduced-diameter front end 14a and an enlarged rear end 14b. The housing has an inner wall 12a within which the enlarged rear end of the contact member is slidably disposed. The housing also has an open front end 12b and a closed rear end 12c. Coil spring 16 is sandwiched or “loaded” between closed rear end 12c of the housing and rear end 14b of the contact member to bias the contact member forwardly as shown in FIG. 1. The closed end of the housing or terminal is fixed to an electrical device by soldering, and front end 14a of the contact member pressure engages a second electrical device, whereby terminal 10 electrically couples the two electrical devices. Therefore, the prior art terminal 10 of FIG. 1A has a fixed end and only one pressure contacting end or function.

Another prior art pressure engaging terminal is shown in FIG. 1B and is generally designated 20. The terminal includes a housing 22, a first contact member 24, a second contact member 26 and a coil spring 28. Contact member 24 has a reduced-diameter outer end 24a and an enlarged inner end 24b. Contact member 26 has a reduced-diameter outer end 26a and an enlarged inner end 26b. Housing 22 has an opening 22a at one end thereof through which the outer end 24a of contact member 24 projects. The housing has an opening 22b at the opposite end thereof through which outer end 26a of terminal 26 projects. The housing may be fabricated of dielectric material and include a bore 22c extending between and communicating with openings 22a and 22b. The bore is lined with a conductive inner tube 29 which defines a through hole 29a within which the enlarged rear ends 24b and 26b of contact members 24 and 26, respectively, are slidably disposed. Coil spring 28 preferably is of conductive metal material and is effective to bias contact members 24 and 26 in opposite directions for making pressure contacting engagement between a pair of electrical devices.

Whereas prior art terminal 10 in FIG. 1A has a single pressure contacting end or function, prior art terminal 20 in FIG. 1B has two opposite pressure contacting ends or functions. However, both terminals require separate housings. Housing 12 of terminal 10 is fabricated of conductive metal material and the open end of the housing (at opening 12b) must be riveted or bent about contact member 14 during assembly. Housing 22 of prior art terminal 20 creates additional problems of assembling contact members 24 and 26 within the housing. If the housing is fabricated of dielectric material, the opposite ends of the housing are difficult to precisely mold about the contact members. If the housing is fabricated of conductive metal material, the multiple riveting or bending processes are not cost effective. The present invention is directed to solving these problems and providing improvements in such electrical terminals, particularly in providing an extremely simple electrical terminal having pressure engaging contact members or functions at opposite ends thereof.

### SUMMARY OF THE INVENTION

An object, therefore, of the invention is to provide a new and improved electrical terminal of the character described.

In the exemplary embodiment of the invention, the terminal includes a first contact member having an outer pressure contacting end portion of a given diameter for pressure engaging a first electrical device. The first contact member has an inner end portion of a diameter at least slightly larger than the given diameter of the outer end portion. A second contact member has a front pressure contacting end for pressure engaging a second electrical device. The second contact member has a rear end formed with a hole for reciprocally receiving the inner end portion of the first contact member. A restricted stop is formed at the rear end of the hole for abutting the inner end portion of the first contact member to define an outer limit position of the first contact member. A biasing member is disposed in the hole in the second contact member and is engageable with the inner end portion of the first contact member. The biasing member resiliently biases the first and second contact members in opposite directions. This terminal construction completely eliminates the housings of the prior art.

As disclosed herein, the outer pressure contacting end portions of the first and second contact members are dome shaped to present rounded convex contact surfaces for engaging the two electrical devices. The biasing member is a coil spring having opposite ends engageable with the inner end portion of the first contact member. Preferably, the inner end portion of the first contact member and the hole in the second member are circular in cross-section.

According to one aspect of the invention, the second contact member includes an outwardly projecting bearing flange for reciprocally engaging a bearing surface on the second electrical device. In the exemplary embodiment, the bearing flange comprises a peripheral bearing ring about the second contact member. The bearing ring is located near the rear end of the second contact member.

According to another aspect of the invention, a second electrical device is provided and includes a housing having a mounting cavity with a fixed contact at a base of the cavity. The rear end of the second contact member is reciprocally mounted in the cavity, with the bearing ring slidably engageable with the inner walls of the cavity. The pressure contacting end portion of the first contact member is biased into engagement with the fixed contact at the base of the cavity. The pressure contacting end of the second contact member projects from the housing. The cavity has a restricted stop at an open end thereof for abutting the bearing ring to define an outer limit position of the second contact member projecting from the housing.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIGS. 1A and 1B are longitudinal sectional views through prior art terminals as described in the Background, above;

FIG. 2 is an exploded perspective view of an electrical terminal according to the invention;

FIG. 3 is a perspective view of the terminal of FIG. 1 in assembled condition;

FIG. 4 is a longitudinal or axial section through the terminal;

FIG. 5 is a view similar to that of FIG. 4, with the terminal mounted in a housing of an electrical device; and

FIG. 6 is a view similar to that of FIG. 5, with the terminal sandwich between the electrical device of FIG. 5 and a second electrical device.

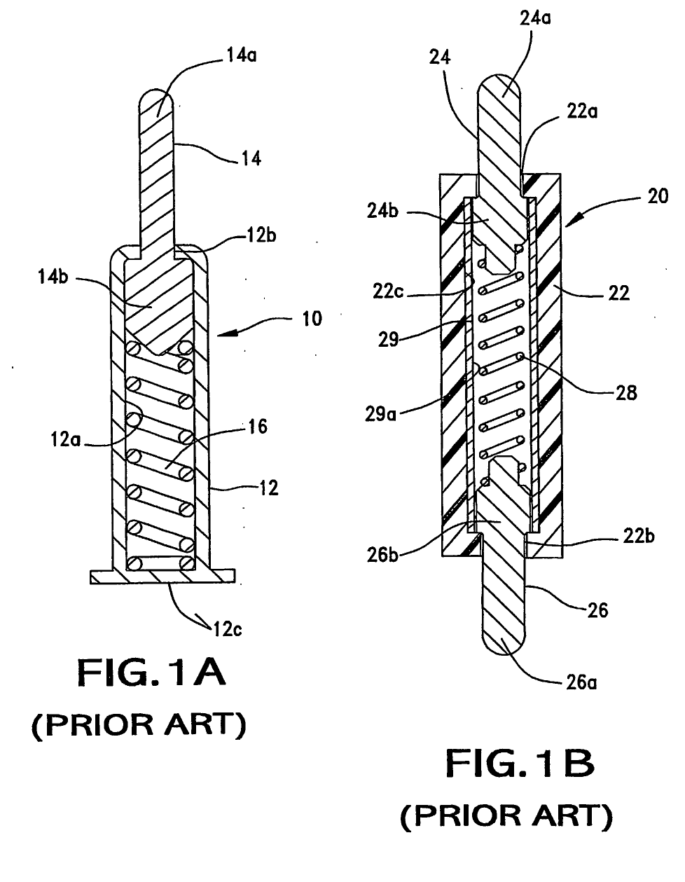

### DETAILED DESCRIPTION OF THE PREFERRED EMBODIMENT

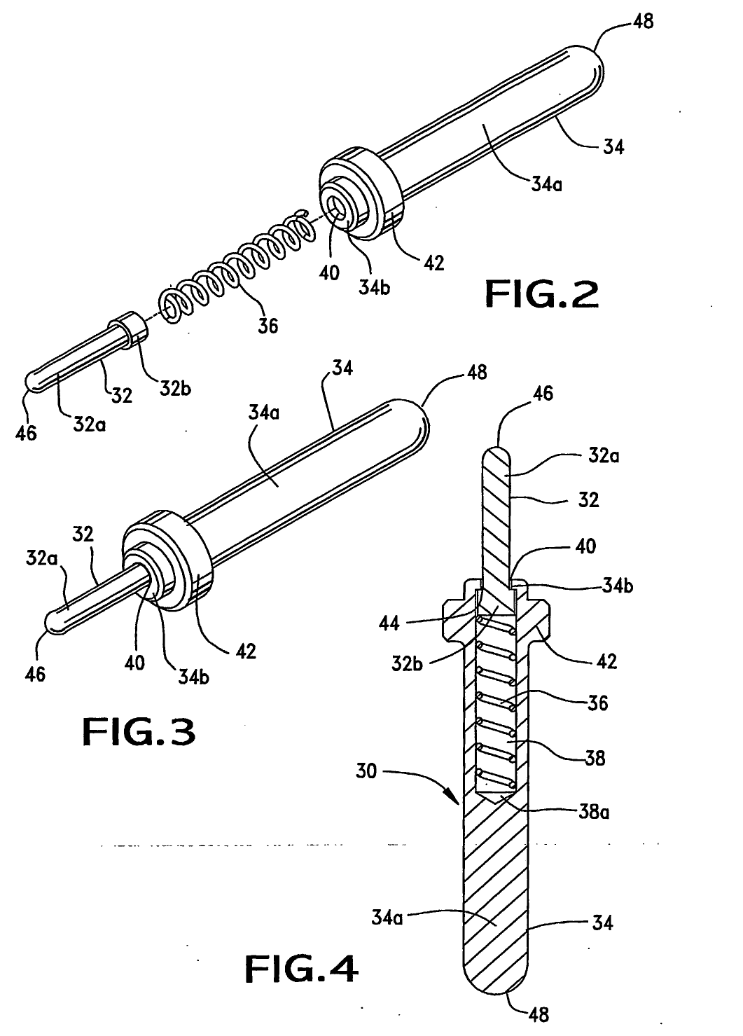

Referring to the drawings in greater detail, and first to FIGS. 2-4, the invention is embodied in a double-ended pressure-contacting electrical terminal, generally designated 30. The terminal is extremely simple and includes only three components, namely: a first contact member 32, a second contact member 34 and a biasing member in the form of a coil spring 36. The contact members are fabricated of conductive material such as metal.

First contact member 32 includes an elongated, outer pressure contacting end portion 32a of a given diameter for pressure engaging a first electrical device as described hereinafter. The first contact member includes an inner end portion 32b of a diameter larger than the given diameter of outer end portion 32a.

Second contact member 34 has an elongated, front pressure contacting end 34a for pressure engaging a second electrical device as described hereinafter. A rear end 34b of the second contact member has a cylindrical hole 38 for reciprocally receiving the inner end portion 32b of first contact member 32, while outer end portion 32a of the first contact member extends through an opening 40 at the rear end of the second contact member. Coil spring 36 is compressed between inner end portion 32b of the first contact member and a bottom or base 38a of cylindrical hole 38 in the second contact member to bias the outer end portion 32a of the first contact member outwardly relative to the second contact member. Finally, the second contact member is provided or formed with an outwardly projecting bearing flange 42 which extends completely around the second contact member to form a peripheral bearing ring for purposes described hereinafter. The bearing ring is located near the rear end 34b of the second contact member.

During assembly, coil spring 36 first is inserted into cylindrical hole 38 in second contact member 34. The enlarged inner end portion 32b of first contact member 32 then is assembled into the hole on top of the coil spring to compress the spring. Rear end 34b of the second contact member then is riveted or bent to capture the inner end portion 32b of the first contact member within the rear end of the second contact member within the rear end of cylindrical hole 38. The riveting or bending of rear end 34b of the second contact member defines a circular restricted stop 44 at the rear end of hole 38 for abutting the inner end portion 32b of the first contact member to define an outer limit position of the outer end portion 32a of the first contact member.

As can be seen in the drawings, outer end portion 32a of first contact member 32 and front end 34a of second contact member 34 are dome shaped to present rounded convex contact surfaces 46 for the first contact member and 48 for the second contact member, for engaging appropriate electrical devices as shown hereinafter. Preferably, the inner end portion 32b of first contact member 32 as well as hole 38 in the second contact member are circular in cross-section.

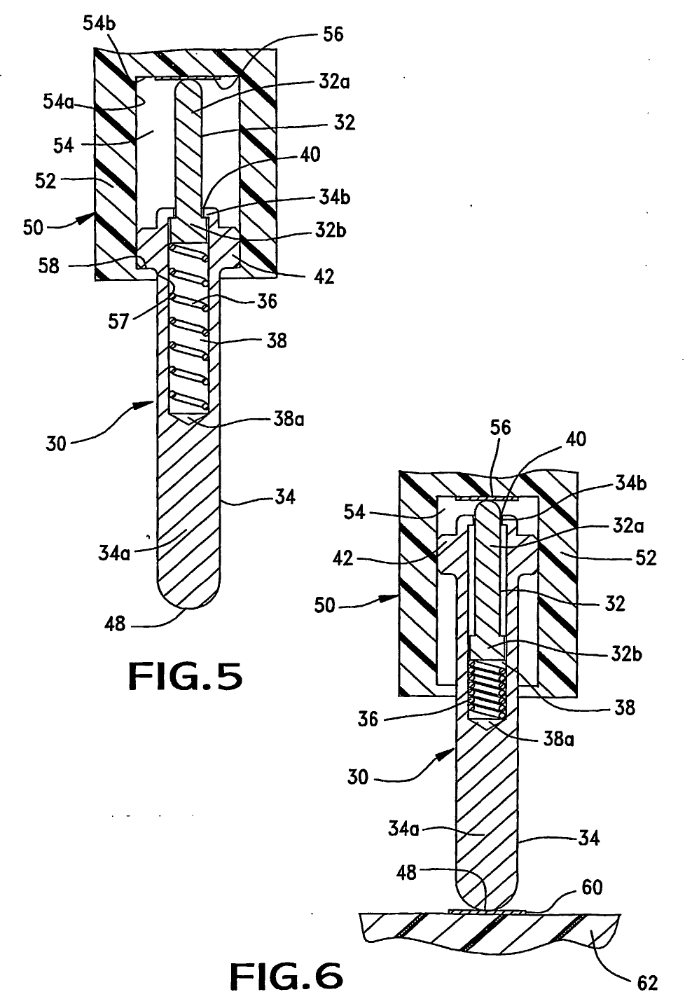

Referring to FIG. 5, terminal 30 is shown assembled to a first electrical device, generally designated 50. The first electrical device includes a housing 52 having a mounting cavity 54 defined by inner walls 54a. A fixed contact 56 is fixed to a base 54b of the mounting cavity. The housing has an opening 57 communicating with the cavity, and a restricted stop 58 is formed about the opening at the interior of the cavity.

When terminal 30 is mounted in first electrical device 50, rear end 34b of second contact member 34 is reciprocally mounted within mounting cavity 54 of housing 52 of the first electrical device, with bearing ring 42 sidably engageable with inner walls 54a of cavity 54. Pressure contacting end portion 32a of first contact member 32 is biased by coil spring 36 into engagement with fixed contact 56 at base 54b of the cavity. The pressure contacting end 34a of second contact member 34 projects through opening 56 and from housing 52. Restricted stop 58 at opening 57 of housing 52 abuttingly engages bearing ring 42 to define an outer limit position of second contact member 34 projecting from housing 52, as seen in FIG. 5.

FIG. 6 shows terminal 30 mounted within housing 52 of first electrical device 50, as described above in relation to FIG. 5, and with second contact member 34 of the terminal engaging a fixed contact 60 of a second electrical device 62. It can be seen that second contact member 34 has been pushed inwardly into mounting cavity 54 of first electrical device 50, in the direction of arrow “A”. This compresses coil spring 36 which, in turn, biases the first and second contact members 32 and 34, respectively, in opposite directions into pressure contacting engagement with fixed contacts 56 and 60, respectively, of the first and second electrical devices 50 and 62, respectively. Therefore, the simple construction of the two inter-mounted contact members 32 and 34 are effective to electrically couple the two fixed contacts of the two electrical devices without the use of any extraneous housings whatsoever.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. An electrical terminal (30), for mounting in a mounting cavity (54) in a first electrical device (50) with one open end (57) comprising:
a first contact member (32) having an outer pressure contacting end portion (32a) of a given diameter for pressure engaging a first electrical device (50) and an inner end portion (32b) of a diameter at least slightly larger than said given diameter;
a second contact member (34) having a front pressure contacting end (34a) for pressure engaging a second electrical device (62), a rear end (34b) having a hole (38) for reciprocally receiving the inner end portion of the first contact member, a restricted stop (44) at the rear end of the hole for abutting the inner end portion of the first contact member to define an outer limit position of the first contact member, an outwardly projecting bearing flange (42) for reciprocally engaging a bearing surface (54a) on the first electrical device (50);
a biasing member (36) in said hole in the second contact member and engageable with the inner end portion of the first contact member for resiliently biasing the first and second contact members in opposite directions; and
the first electrical device (50) having a housing (52) with the enclosed mounting cavity (54), the mounting cavity with a fixed contact (56) at a base (54b) of the cavity opposite said open end (57), the rear end (34b) of the second contact member (34) being reciprocally mounted in the cavity with said bearing ring (42) slidably engageable with inner walls (54a) of the cavity, the pressure contacting end portion (32a) of the first contact member (32) being biased into engagement with the fixed contact at the base of the cavity, the pressure contacting end (34a) of the second contact member (34) projecting from the housing, and the cavity has a restricted stop (58) at an open end (57) thereof for abutting the bearing ring to define an outer limit position of the second contact member projecting from the housing.

2. The electrical terminal of claim 1 wherein the outer pressure contacting end portion (32a) of said first contact member (32) is dome shaped to present a rounded convex contact surface (46) for engaging the first electrical device (50).

3. The electrical terminal of claim 1 wherein the outer pressure contacting end (34a) of said second contact member (34) is dome shaped to present a rounded convex contact surface (48) for engaging the second electrical device (62).

4. The electrical terminal of claim 3 wherein the outer pressure contacting end portion (32a) of said first contact member (32) is dome shaped to present a rounded convex contact surface (46) for engaging the first electrical device (50).

5. The electrical terminal of claim 1 wherein said biasing member comprises a coil spring (36) having one end engageable with the inner end portion (32b) of the first contact member (32) and an opposite end engageable with a bottom (38a) of the hole (38).

6. The electrical terminal of claim 1 wherein said inner end portion (32b) of the first contact member (32) and said hole (38) in the second contact member (34) are circular in cross-section.

7. The electrical terminal of claim 1 wherein said bearing flange comprises a peripheral bearing ring (42) about the second contact member (34).

8. The electrical terminal of claim 8 wherein said bearing ring (42) is located near the rear end (34b) of the second contact member (34).

9. An electrical terminal (30) for mounting in an enclosed mounting cavity (54) in a first electrical device (50) with one open end (57), comprising:
a first contact member (32) having an outer pressure contacting end portion (32a) of a given diameter for pressure engaging a first electrical device (50) and an inner end portion (32b) of a diameter at least slightly larger than said given diameter, the outer pressure contacting end portion being dome shaped to present a rounded convex contact surface (46) for engaging the first electrical device;
a second contact member (34) having a front pressure contacting end (34a) for pressure engaging a second electrical device (62), a rear end (34b) having a hole (38) for reciprocally receiving the inner end portion of the first contact member, and a restricted stop (44) at the rear end of the hole for abutting the inner end portion of the first contact member to define an outer limit position of the first contact member, the outer pressure contacting end being dome shaped to present a rounded convex contact surface (48) for engaging the second electrical device;
said inner end portion (32b) of the first contact member (32) and said hole (38) in the second contact member (34) being circular in cross-section;
a coil spring (36) in said hole (38) in the second contact member and engageable with the inner end portion of the first contact member for resiliently biasing the first and second contact members in opposite directions; and
said first electrical device (50) including a housing (52) having the enclosed mounting cavity (54) with a fixed contact (56) at a base (54b) of the cavity opposite the open end (57), the rear end (34b) of the second contact member (34) being reciprocally mounted in the cavity with a bearing flange (42) slidably engageable with inner walls (54a) of the cavity, the pressure contacting end portion (32a) of the first contact member (32) being biased into engagement with the fixed contact at the base of the cavity, the pressure contacting end (34a) of the second contact member (34) projecting from the housing, and the cavity has a restricted stop (58) at an open end (57) thereof for abutting the bearing flange to define an outer limit position of the second contact member projecting from the housing.

10. The electrical terminal of claim 12 wherein said bearing flange comprises a peripheral bearing ring (42) about the second contact member (34).

11. The electrical terminal of claim 13 wherein said bearing ring (42) is located near the rear end (34b) of the second contact member (34).
